(19) United States
(12) Patent Application Publication
(10) Pub. No.: US 2014/0156340 A1
(43) Pub. Date: Jun. 5, 2014

(54) SYSTEM AND METHOD FOR IDENTIFYING OUTLIER RISKS

(71) Applicant: BANK OF AMERICA CORPORATION, Charlotte, NC (US)

(72) Inventor: Daniel C. Kern, Charlotte, NC (US)

(73) Assignee: Bank of America Corporation, Charlotte, NC (US)

(21) Appl. No.: 13/692,532

(22) Filed: Dec. 3, 2012

(51) Int. Cl. G06Q 10/06

(52) U.S. Cl. CPC G06Q 10/0635
USPC 705/7.28

(57) ABSTRACT

To identify outlier risks, a risk assessment is received from a first computer, and the risk assessment comprises a plurality of risks and each risk comprises a plurality of words and a plurality of attributes. A risk category associated with the risk assessment is received from a second computer, and the risk category is based on the plurality of words and the plurality of attributes and the risk category is a selected one of a high risk category and a not-high risk category. A word count is calculated for each word in each risk category. A probability score is also calculated for each word to generate a plurality of probability scores associated with the risk, and a risk score is calculated for each risk and is based on the plurality of probability scores associated with the risk. A distribution is generated that indentifies the high risk category and the not-high risk category, and the distribution identifies the risk score in the associated risk category. It is determined whether the risk associated with the risk score is an outlier for the associated risk category.

### TECHNICAL FIELD OF THE INVENTION

This invention relates generally to risk analysis, and more particularly to identifying outlier risks.

### BACKGROUND OF THE INVENTION

Organizations may employ various techniques to document risks and identify documented risks that require additional attention. Typically, organizations use humans to employ ad-hoc methods to evaluate risk. These methods can result in inconsistent risk identification and an inability to prioritize various risks for additional analysis, particularly when there is a large number of risks to evaluate.

### SUMMARY OF THE INVENTION

According to embodiments of the present disclosure, disadvantages and problems associated with identifying outlier risks may be reduced or eliminated.

In certain embodiments, to identify outlier risks, a risk assessment is received from a first computer, and the risk assessment comprises a plurality of risks and each risk comprises a plurality of words and a plurality of attributes. A risk category associated with the risk assessment is received from a second computer, and the risk category is based on the plurality of words and the plurality of attributes and the risk category is a selected one of a high risk category and a not-high risk category. A word count is calculated for each word in each risk category. A probability score is also calculated for each word to generate a plurality of probability scores associated with the risk, and a risk score is calculated for each risk and is based on the plurality of probability scores associated with the risk. A distribution is generated that indentifies the high risk category and the not-high risk category, and the distribution identifies the risk score in the associated risk category. It is determined whether the risk associated with the risk score is an outlier for the associated risk category.

Certain embodiments of the present disclosure may provide one or more technical advantages. A technical advantage of one embodiment includes calculating values for text that facilitates the identification of risks to be evaluated further. Another technical advantage of an embodiment includes calculating a risk score based on the word values and the risk category, which also facilitates the identification of risk to be further evaluated. Yet another technical advantage of an embodiment includes identifying risks with scores that are outliers from similarly rated risks and communicating the risk assessments to a computer for further evaluation.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates a block diagram of a system for identifying outlier risks;

FIG. 2 illustrates an example table that includes word counts and probability scores for a plurality of words;

FIG. 3 illustrates example distributions of the calculated scores of the risks for each risk category; and

FIG. 4 illustrates an example flowchart for identifying outlier risks.

### DETAILED DESCRIPTION OF THE INVENTION

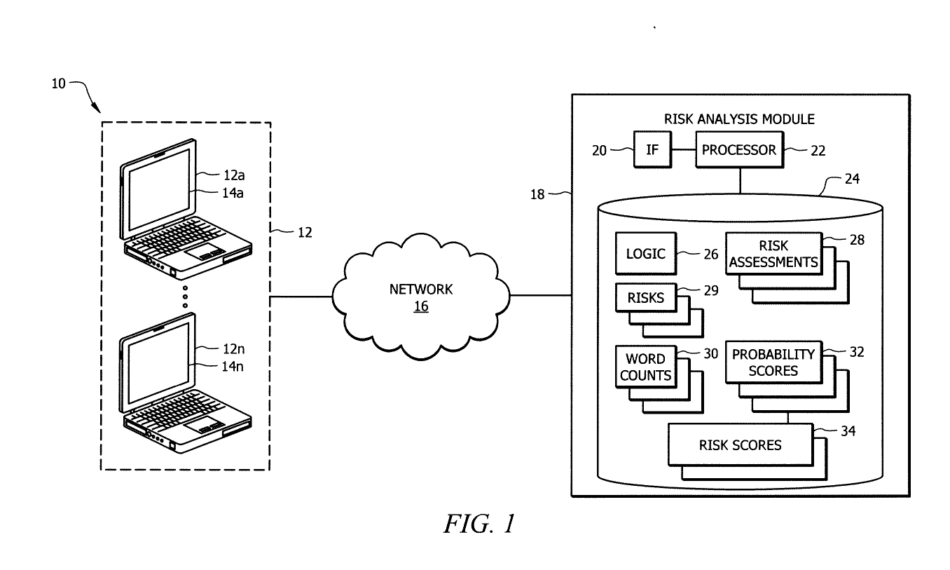

Embodiments of the present invention and its advantages are best understood by referring to FIGS. 1 through 4 of the drawings, like numerals being used for like and corresponding parts of the various drawings.

Organizations evaluate and manage operational risk as part of the organization's functions. To evaluate and manage that risk, organizations may employ various processes to gather information and evaluate the information that impacts the organization's risk. According to the described embodiments, organizations use risk assessments to gather information regarding potential risks associated with the organization's processes. If an organization has many processes, that increases the amount of information gathered and evaluated to determine an organization's risk in a particular area. Therefore, it is advantageous to provide a repeatable, objective method that facilitates the processing of the risk assessments and identifies outlier risks that may need further investigation.

FIG. 1 illustrates a block diagram of a system for identifying outlier risks. System 10 includes one or more computers 12 that communicate over one or more networks 16 with risk analysis module 18 within an organization. Computers 12 interact with risk analysis module 18 and provide completed risk assessments that risk analysis module 20 analyzes to identify risk outliers.

System 10 includes computers 12a-12n, where n represents any suitable number, that communicate with risk analysis module 18 through network 16. For example, computer 12 communicates a completed risk assessment to risk analysis module 18. As another example, computer 12 receives distribution information from risk analysis module 18 that identifies outlier risks in a graphical format. As yet another example, computer 12 communicates a risk category associated with a risk to risk analysis module 18. In the illustrated embodiment, risk managers, associates, employees, or other suitable individuals in the organization use computer 12. In an embodiment, an associate communicates a completed risk assessment to risk analysis module 18 and a risk manager communicates risk categories associated with the various risks in the risk assessment to risk analysis module 18. Computer 12 may include a personal computer, a workstation, a laptop, a wireless or cellular telephone, an electronic notebook, a personal digital assistant, a smartphone, a netbook, a tablet, a slate personal computer, or any other device (wireless, wireline, or otherwise) capable of receiving, processing, storing, and/or communicating information with other components of system 10. Computer 12 may also comprise a user interface, such as a display, keyboard, mouse, or other appropriate terminal equipment.

In the illustrated embodiment, computer 12 includes a graphical user interface (“GUI”) 14 that displays information received from risk analysis module 18 and/or information communicated to risk analysis module 18. For example, GUI 14 may display a risk assessment for a user to complete. As another example, GUI 14 may display a graphical distribution of the analyzed risks. GUI 14 is generally operable to tailor and filter data entered by and presented to the user. GUI 14 may provide the user with an efficient and user-friendly presentation of information using a plurality of displays having interactive fields, pull-down lists, and buttons operated by the user. GUI 14 may include multiple levels of abstraction including groupings and boundaries. It should be understood that the term GUI 14 may be used in the singular or in the plural to describe one or more GUIs 14 in each of the displays of a particular GUI 14.

Network 16 represents any suitable network operable to facilitate communication between the components of system 10, such as computers 12 and risk analysis module 18. Network 16 may include any interconnecting system capable of transmitting audio, video, signals, data, messages, or any combination of the preceding. Network 16 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Risk analysis module 18 represents any suitable component that facilitates the analysis of risk assessments to identify outlier risks. Risk analysis module 18 may include a network server, any suitable remote server, a mainframe, a host computer, a workstation, a web server, a personal computer, a file server, or any other suitable device operable to communicate with computers 12. In some embodiments, risk analysis module 18 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of risk analysis module 18 may be performed by any suitable combination of one or more servers or other components at one or more locations. In the embodiment where risk analysis module 18 is a server, the server may be a private server, or the server may be a virtual or physical server. The server may include one or more servers at the same or remote locations. Also, risk analysis module 18 may include any suitable component that functions as a server. In the illustrated embodiment, risk analysis module 18 includes a network interface 20, a processor 22, and a memory 24.

Network interface 20 represents any suitable device operable to receive information from network 16, transmit information through network 16, perform processing of information, communicate with other devices, or any combination of the preceding. For example, network interface 20 receives a risk assessment from computer 12. As another example, network interface 20 receives a risk category associated with a risk in the risk assessment from computer 12. As yet another example, network interface 20 communicates a distribution report to computer 12. Network interface 20 represents any port or connection, real or virtual, including any suitable hardware and/or software, including protocol conversion and data processing capabilities, to communicate through a LAN, WAN, or other communication system that allows risk analysis module 18 to exchange information with computers 12, network 16, or other components of system 10.

Processor 22 communicatively couples to network interface 20 and memory 24, and controls the operation and administration of risk analysis module 18 by processing information received from network interface 20 and memory 24. Processor 22 includes any hardware and/or software that operates to control and process information. For example, processor 22 executes logic 26 to control the operation of risk analysis module 18. Processor 22 may be a programmable logic device, a microcontroller, a microprocessor, any suitable processing device, or any suitable combination of the preceding.

Memory 24 stores, either permanently or temporarily, data, operational software, or other information for processor 22. Memory 24 includes any one or a combination of volatile or non-volatile local or remote devices suitable for storing information. For example, memory 24 may include random access memory (RAM), read only memory (ROM), magnetic storage devices, optical storage devices, or any other suitable information storage device or a combination of these devices. While illustrated as including a particular module, memory 24 may include any suitable information for use in the operation of risk analysis module 18. In the illustrated embodiment, memory 24 includes logic 26, risk assessments 28, risks 29, word counts 30, probability scores 32, and risk scores 34.

Logic 26 generally refers to logic, rules, algorithms, code, tables, and/or other suitable instructions embodied in a computer-readable storage medium for performing the described functions and operations of risk analysis module 18. For example, logic 26 facilitates the analysis of risk assessments 28 and risks 29 received from computers 12. Logic 26 facilitates the identification of words to analyze, which may be referred to as token words. In an embodiment, logic 26 facilitates the determination of word counts 30, probability scores 32, and risk scores 34.

Risk assessments 28 generally refer to information received from computers 12 that identify potential risks for an organization. Risk assessment 28 may include a combination of structured data (e.g., fields with drop-down menus) and unstructured data (e.g., free-form text). In a particular embodiment, risk assessment 28 may include the following information: a risk identifier, a risk description, and an inherent risk rating. In an embodiment, a user using computer 12 completes the information in risk assessment 28 and communicates risk assessment 28 to risk analysis module 18.

Risks 29 represent the various risks identified in risk assessments 28. Risks 29 may be identified according to a numerical identifier, a description, an inherent risk rating, any other suitable information, or any suitable combination of the proceeding. Risks 29 may be described using a combination of structured data (e.g., fields with drop-down menus) and unstructured data (e.g., free-form text). For example, risks 29 include a plurality of words and attributes that describe the risk being identified. Each risk 29 has an associated risk category. A user using computer 12 may indicate the risk category to associate with risk 29. The risk category may include any suitable category that indicates a ranking of the risk. For example, the risk category may include a high risk category and a not-high risk category. The not-high risk category may be further divided into a low risk category and a moderate risk category.

Word counts 30 generally refer to the quantization of text used to describe risks 29. Risk analysis module 18 quantifies text from risks 29 for additional analysis. For example, risk analysis module 18 may determine how many times a word appears in the various risk categories, and will assign a score based on that determination. As another example, risk analysis module 26 may quantify the terms based on expert opinion or structured data. Also, terms may also be quantified based on their association with a materialized risk. For example, if a risk has materialized, then risk analysis module 18 determines the text associated with that materialized risk, and determine word count 30 based on the association. Memory 24 may store word counts 30 to be used in additional analysis of risks 29.

Probability scores 32 generally refer to the probability that risk 29 containing a particular word is a high risk knowing that the particular word is in risk 29 (i.e., Pr(H|W)). Using word counts 30, risk analysis module 18 determines probability scores 32 for the words in risk 29. Risk analysis module 18 uses word counts 30 to also determine the following: the overall probability that risk 29 is categorized as high risk (i.e., Pr(H)), the overall probability that the risk 29 is categorized as a not-high risk (i.e., Pr(NH)), the probability that the particular word appears in risk 29 categorized as a high risk (i.e., Pr(W|H)), and the probability that the particular word appears in risk 29 categorized as a not-high risk (i.e., Pr(W|NH)), which may be used to determine probability score 32. Risk analysis module 18 may use the following formula to determine probability score 32 for each word:

Pr(H|W)=[Pr(W|H)·Pr(H)]/[Pr(W|H)·Pr(H)+Pr(W|NH)·Pr(NH)]

Memory 24 stores probability scores 32 to be used to create a distribution of risk scores 34.

Risk score 34 generally refers to the score associated with each risk 29. To determine risk score 34, risk analysis module 18 may combine probability scores 32 associated with the text in risk 29. For example, risk analysis module 18 may sum the plurality of probability scores 32 to calculate risk score 34. As another example, risk analysis module 18 multiplies probability scores 32 of each word that appears in the text of risk 29 to calculate risk score 34. As yet another example, risk analysis module 18 implements the following equation to combine probability scores 32 to calculate risk score 34:

$$r = \frac{{p}_{1} {p}_{2} … {p}_{N}}{{p}_{1} {p}_{2} … {p}_{N} + ( 1 - {p}_{1} ) ( 1 - {p}_{2} ) … ( 1 - {p}_{N} )}$$

where “r” is the risk score and “p_{N}” is the probability score for the Nth word.

In an exemplary embodiment of operation, risk analysis module 18 receives completed risk assessments 28 from computers 12. In an embodiment, each risk assessment 28 may include various risks 29, and each risk 29 is associated with a particular risk category, such as a high-risk category and a not-high risk category. A user using computer 12 may associate a risk category with risk 29.

Risk analysis module 18 determines the text in risk 29 to evaluate, and separates the text into individual words. Risk analysis module 18 calculates a word count 30 for each token word in each risk category. Using word counts 30, risk analysis module 18 calculates a probability score 32 for each token word, which represents the probability that risk 29 is categorized as high risk knowing that the token word is in risk 29. Using probability scores 32, risk analysis module 18 determines risk score 34 for each risk 29. Risk analysis module 18 may then generate a distribution for each risk category based on risk scores 34. If risk 29 falls outside of the expected range of distribution for the risk category due to risk score 34, risk analysis module 18 identifies risk 29 and communicates risk 29 to computer 12 for further evaluation.

A component of system 10 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, system 10 may include any number of computers 12, networks 16, and risk analysis module 18. As another example, memory 24 may also store risk assessment scores that represent the combination of the risk scores 34 associated with risks 29 in risk assessment 28. Additionally, risk analysis module 18 may generate a graphical representation of risk assessment scores similar to that described with respect to risk scores 34 and communicate the risk assessment scores to computers 12 for additional evaluation. Any suitable logic may perform the functions of system 10 and the components within system 10.

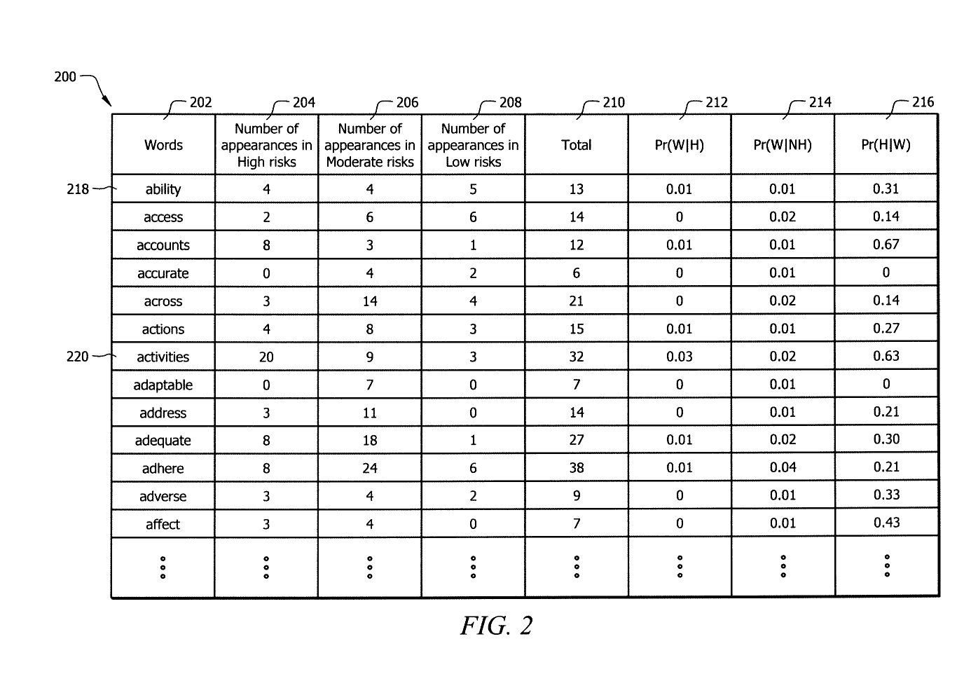

FIG. 2 illustrates an example chart 200 that includes word counts and probability scores for a plurality of words. Chart 200 includes a number of columns that represent information used by risk analysis module 18 to evaluate risk assessments 28. Column 202 identifies words that risk analysis module 18 will evaluate. Risk analysis module 18 may determine which words to evaluate, or an administrator may determine the words to evaluate and input this information into risk analysis module 18.

Columns 204, 206, and 208 identify the word counts in the associated risk categories for each token word. Column 204 indicates the number of times a word appears in risks 29 categorized as high risk. Column 206 indicates the number of times a word appears in risks 29 categorized as moderate risk. Column 208 indicates the number of times a word appears in risks 29 categorized as low risk. For example, in row 218, the token word to analyze is “ability.” Row 218 indicates that “ability” appears in four risks 29 that are categorized as high, appears in four risks 29 that are categorized as moderate, and appears in five risks 29 that are categorized as low. As another example, row 220 identifies “activities” as the token word to analyze. Row 220 indicates that “activities” appears in twenty risks 29 categorized as high, appears in nine risks 29 categorized as moderate, and appears in three risks 29 categorized as low. Column 210 indicates the total of the number of appearances. The illustrated embodiment indicates the total as a sum of the number of appearances. In row 218, the total number of appearances of the word “ability” in risks 29 is thirteen, and the total number of appearances of the word “activities” is thirty-two.

Columns 212, 214, and 216 indicate the probability of different events occurring. Column 212 indicates the probability that the token word appears in risks 29 categorized as a high risk (i.e., Pr(W|H)). In the illustrated embodiment, there is a 1% chance that the token word “ability” appears in risks 29 categorized as high risk and a 3% chance that the token word “activities” appears in risks 29 categorized as high risk. Column 214 indicates the probability that the token word appears in risks 29 categorized as a not-high risk (i.e., Pr(W|NH)). In the illustrated embodiment, there is a 1% chance that the token word “ability” appears in risks 29 categorized as not-high risk and a 2% chance that the token word “activities” appears in risks 29 categorized as not-high risk. Column 216 identifies the probability score 32 for a token word, which indicates the probability that risks 29 containing the token word is categorized as high risk knowing that the token word is in risk 29. In the illustrated embodiment, there is a 31% chance that risks 29 containing the word “ability” are categorized as high risk knowing that “ability” appears in risk 29. As another example, there is a 63% chance that risks 29 are categorized as high risk knowing that “activities” appears in risk 29.

Modifications, additions, or omissions may be made to chart 200 without departing from the scope of the invention. While the illustrated embodiment represents example token words, chart 200 may include any suitable token word for risk analysis module 18 to evaluate.

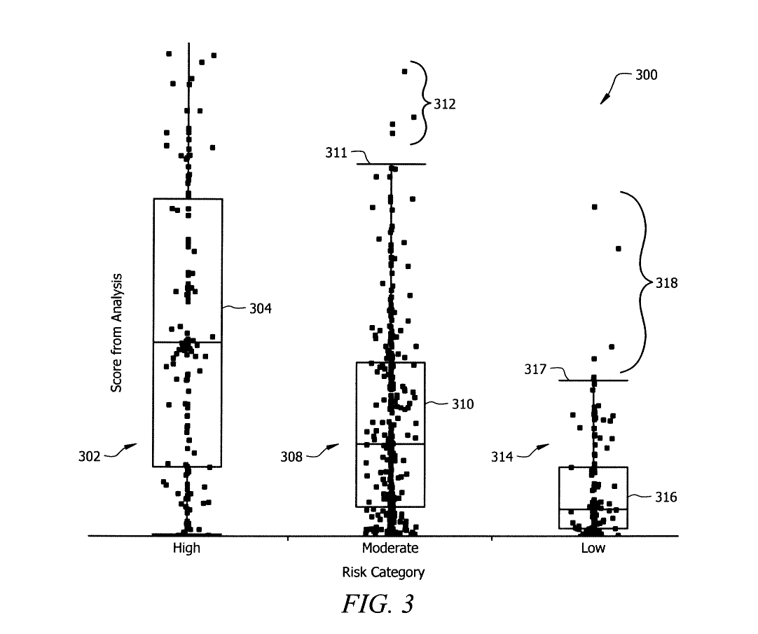

FIG. 3 illustrates example distributions 300 of the calculated scores of the risks 29 for each risk category. In the illustrated embodiment, distribution 300 is represented as a box plot that indicates which risks 29 are considered outliers. Distribution 300, however, may be represented in any suitable graphical form that identifies outliers and allows for a comparison of distributions on a single chart. Risk analysis module 18 may communicate distribution 300 to computers 12 for display and to facilitate further analysis. Distribution 300 includes each risk category on the x-axis of the distribution and includes the scores from the analysis on the y-axis. Risks 29 are plotted according to risk score 34. In an embodiment, each risk 29 is identified according to its risk identifier.

Plot 302 represents risks 29 that are associated with the high risk category. Box 304 represents the distribution of risks 29 in the high risk category.

Plot 308 represents risks 29 that are associated with the moderate risk category. Box 310 represents the center of the distribution of risks 29 in the moderate risk category. In the illustrated embodiment, whisker 311 represents the upper quartile+1.5*the interquartile range. Area 312 includes risks 29 that appear outside of the expected range of the distribution in the moderate risk category. These risks 29 have risk scores 34 that are different from the majority of risks 29 that are categorized as a moderate risk. Risks 29 in area 312 may be considered as outliers. Risk analysis module 18 may communicate risks 29 in area 312 to computers 12 for further evaluation.

Plot 314 represents the risks 29 that are associated with the low risk category. Box 316 represents the center of the distribution of risks 29 in the low risk category. In the illustrated embodiment, whisker 317 represents the upper quartile+1.5*the interquartile range. Area 318 includes risks 29 that appear outside of the expected range of the distribution in the low risk category. These risks 29 have risk scores 34 that are different from the majority of risks 29 that are categorized as a low risk. Risks 29 in area 318 may be considered as outliers. Risk analysis module 18 may communicate risks 29 in area 318 to computers 12 for further evaluation.

Modifications, additions, or omissions may be made to distribution 300 without departing from the scope of the invention. For example, distribution 300 may be represented in a different graphical form.

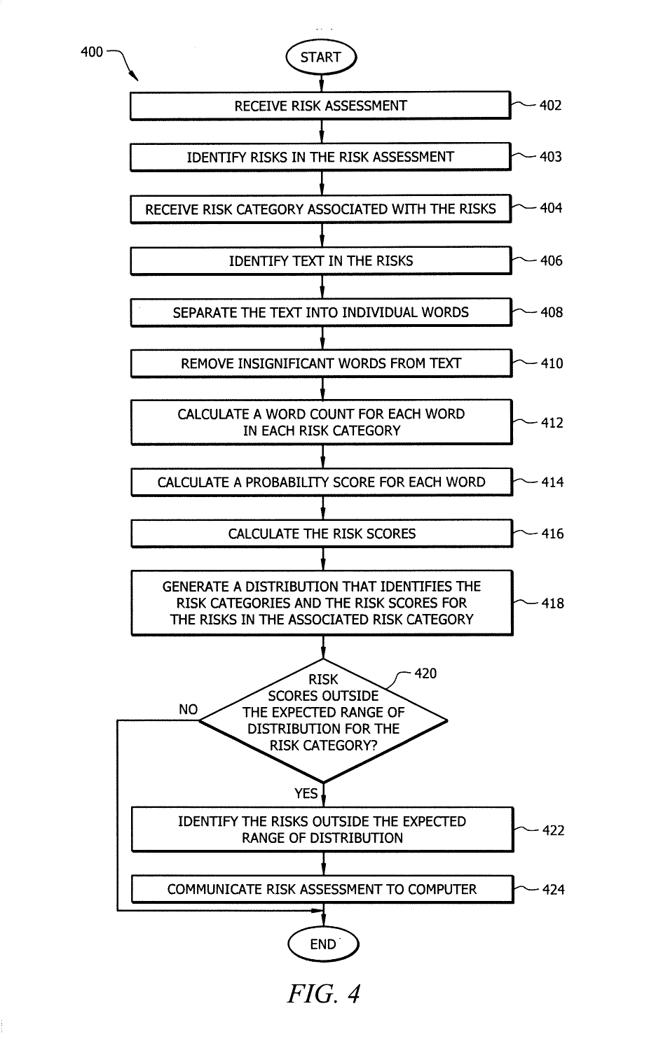

FIG. 4 illustrates an example flowchart 400 for identifying outlier risks. The method begins at step 402 when risk analysis module 18 receives risk assessment 28 from computer 12. In an embodiment, an associate in an organization completes risk assessment 28 using computer 12, and computer 12 communicates the completed risk assessment 28 to risk analysis module 18. Risk analysis module 18 identifies risks 29 in risk assessment 28 for further analysis at step 403. At step 404, risk analysis module 18 receives the risk category associated with risk 29. In an embodiment, a risk manager in an organization associates a risk category to risk 29 using computer 12, and computer 12 communicates the associated risk category to risk analysis module 18. Risk analysis module 18 may store risk 29 and the associated risk category to use during the analysis.

At step 406, risk analysis module 18 identifies text in risks 29, and separates the text into individual words in step 408. Separating the text into individual words facilitates the analysis. In an embodiment, each individual word is tied to the risk identifier to facilitate the grouping of the risk scores associated with the words in the text of risk 29. At step 410, risk analysis module 18 removes insignificant words from the group of individual words. For example, insignificant words may include common words, such as “the,” “a,” “an,” and other common words. Insignificant words may also include words that do not have a significant meaning for risk analysis.

At step 412, risk analysis module 18 calculates a word count for each word in each risk category. In an embodiment, the word count represents the number of times the word appears in each risk category. For example, in row 218, it is shown that “ability” appears in the high risk category four times, in the moderate risk category four times, and in the low risk category four times. Therefore, the word counts for “ability” may be four in the high risk category, four in the moderate risk category, and five in the low risk category. This information may appear in a chart similar to that described with respect to FIG. 2. As another example, risk analysis module 26 may quantify the terms based on expert opinion or structured data. Terms may also be quantified based on their association with a materialized risk. For example, if a risk has materialized, then risk analysis module 18 determines the text associated with that materialized risk, and scores the text based on the association.

At step 414, risk analysis module 18 calculates a probability score for each word. The probability score indicates the probability that risk 29 containing the particular word is categorized as high risk knowing that the particular word is in risk 29. Using the various word counts, the probability score may be calculated as described above with respect to FIG. 1. In other embodiments, risk analysis module 18 may calculate probability scores based on previous information gathered on the particular words. Therefore, risk analysis module 18 may learn how words are being used in risks 29 and calculate probability scores based on that learning, in addition to or alternate to, calculations according to a current use of words in risk 29. Risk analysis module 18 calculates the risk score in step 416 for each risk 29. Each risk score is calculated based on the probability scores associated with the plurality of words in the text. For example, risk analysis module 18 may combine, in any suitable manner, the probability scores of each word that appears in the text of risk 29. In an embodiment, risk analysis module 18 sums the probability scores of each word that appears in the text of risk 29 to calculate the risk score. In another embodiment, risk analysis module 18 multiplies the probability scores of each word that appears in the text of risk 29 to calculate the risk score. In yet another embodiment, risk analysis module 18 implements the following equation to combine the probability scores to calculate the risk score:

$$r = \frac{{p}_{1} {p}_{2} … {p}_{N}}{{p}_{1} {p}_{2} … {p}_{N} + ( 1 - {p}_{1} ) ( 1 - {p}_{2} ) … ( 1 - {p}_{N} )}$$

where “r” is the risk score and “p_{N}” is the probability score for the Nth word.

At step 418, risk analysis module 18 generates a distribution for each of the risk categories. For example, risk 29 has been categorized as a high risk. Risk analysis module 18 determines the risk score of risk 29 and generates a distribution that identifies the risk score of risk 29 in the high risk category. Therefore, risk analysis module 18 can compare risk 29 to similarly categorized risks.

Risk analysis module 18 determines at step 420 whether the risk score is outside a range of expected values of the distribution for the risk category. If the risk score is within the range of expected values for the distribution, the method may end. However, if the risk score is outside the expected range for the distribution and appears to be an outlier, risk analysis module 18 identifies risk 29 outside the expected range for the distribution in step 422 and communicates risk 29 to computer 12 for additional evaluation at step 424. The additional evaluation may include any suitable action, such as re-categorizing risk 29 based on the risk score, evaluating risk 29 further to determine whether corrective action is necessary, prioritizing the risk, re-wording the text used in risk 29 to be more consistent with the identified risk category, or any other suitable action. The process described may continue as additional risks 29 are received or at predetermined periods of time.

Modifications, additions, or omissions may be made to method 400 depicted in FIG. 4. The method may include more, fewer, or other steps. For example, risk analysis module 18 may determine synonyms for an individual word and may assign probability scores to synonyms of the individual word based on the probability score of the similar word. Therefore, the probability score for similar words or words that have the same meaning will be the same. Like the process with synonyms, risk analysis module 18 may determine acronyms for words and assign probability scores to the acronyms based on the different meaning. Also, risk analysis module 18 may include common misspellings of words and have probability scores associated with the common misspellings based on the probability score of the correct spelling. As another example, method 400 may identify a set of words that have the highest probability score. In an embodiment, risk analysis module 18 may determine whether words have different probability scores between iterations of method 400 over time. As yet another example, steps may be performed in parallel or in any suitable order. While discussed as risk analysis module 18 performing the steps, any suitable component of system 10 may perform one or more steps of the method.

Certain embodiments of the present disclosure may provide one or more technical advantages. A technical advantage of one embodiment includes calculating values for text that facilitates the identification of risks to be evaluated further. Another technical advantage of an embodiment includes calculating a risk score based on the word values and the risk category, which also facilitates the identification of risk to be further evaluated. Yet another technical advantage of an embodiment includes identifying risks with scores that are outliers from similarly rated risks and communicating the risk assessments to a computer for further evaluation.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system, comprising
a network interface operable to:
receive, from a first computer, a risk assessment comprising a plurality of risks, wherein each risk comprises a plurality of words and a plurality of attributes; and
receive, from a second computer, a risk category associated with the risk, wherein the risk category is based on the plurality of words and the plurality of attributes and the risk category is a selected one of a high risk category and a not-high risk category;
a processor communicatively coupled to the network interface, the processor operable to:
calculate a word count for each word in each risk category;
calculate a probability score for each word to generate a plurality of probability scores associated with the risk;
calculate a risk score for each risk, wherein the risk score is based on the plurality of probability scores associated with the risk;
generate a distribution that indentifies the high risk category and the not-high risk category, wherein the distribution identifies the risk score in the associated risk category; and
determine whether the risk associated with the risk score is an outlier for the associated risk category.

2. The system of claim 1, wherein the processor is further operable to calculate the word count by determining a total number of times each word appears in each risk category.

3. The system of claim 1, wherein the processor is further operable to remove insignificant words from the plurality of words before the processor calculates the word count.

4. The system of claim 1, wherein the processor is further operable to calculate a probability that the risk assessment is associated with the high risk category if the risk assessment contains a given word.

5. The system of claim 1, wherein the processor is further operable to sum the plurality of probability scores associated with the plurality of words in the risk.

6. The system of claim 1, wherein the processor is further operable to communicate the risk to the second computer if the risk score is an outlier for the associated risk category.

7. The system of claim 1, wherein the processor is further operable to remove insignificant words from the plurality of words before the processor determines the total number of times each word appears in each risk category.

8. Non-transitory computer readable medium comprising logic, the logic, when executed by a processor, operable to:
receive, from a first computer, a risk assessment comprising a plurality of risks, wherein each risk comprises a plurality of words and a plurality of attributes;
receive, from a second computer, a risk category associated with the risk, wherein the risk category is based on the plurality of words and the plurality of attributes and the risk category is a selected one of a high risk category and a not-high risk category;
calculate a word count for each word in each risk category;
calculate a probability score for each word to generate a plurality of probability scores associated with the risk;
calculate a risk score for each risk, wherein the risk score is based on the plurality of probability scores associated with the risk;
generate a distribution that indentifies the high risk category and the not-high risk category, wherein the distribution identifies the risk score in the associated risk category; and
determine whether the risk associated with the risk score is an outlier for the associated risk category.

9. The computer readable medium of claim 8, wherein the logic is further operable to calculate the word count by determining a total number of times each word appears in each risk category.

10. The computer readable medium of claim 8, wherein the logic is further operable to remove insignificant words from the plurality of words before the processor calculates the word count.

11. The computer readable medium of claim 8, wherein the logic is further operable to calculate a probability that the risk assessment is associated with the high risk category if the risk assessment contains a given word.

12. The computer readable medium of claim 8, wherein the logic is further operable to sum the plurality of probability scores associated with the plurality of words in the risk.

13. The computer readable medium of claim 8, wherein the logic is further operable to communicate the risk to the second computer if the risk score is an outlier for the associated risk category.

14. A method, comprising:
receiving, from a first computer, a risk assessment comprising a plurality of risks, wherein each risk comprises a plurality of words and a plurality of attributes;
receiving, from a second computer, a risk category associated with the risk, wherein the risk category is based on the plurality of words and the plurality of attributes and the risk category is a selected one of a high risk category and a not-high risk category;
calculating, by a processor, a word count for each word in each risk category;
calculating, by the processor, a probability score for each word to generate a plurality of probability scores associated with the risk;
calculating, by the processor, a risk score for each risk, wherein the risk score is based on the plurality of probability scores associated with the risk;
generating, by the processor, a distribution that indentifies the high risk category and the not-high risk category, wherein the distribution identifies the risk score in the associated risk category; and
determining, by the processor, whether the risk associated with the risk score is an outlier for the associated risk category.

15. The method of claim 14, wherein calculating the word count comprises calculating the word count by determining a total number of times each word appears in each risk category.

16. The method of claim 14, further comprising removing insignificant words from the plurality of words before the processor calculates the word count.

17. The method of claim 14, wherein the not-high risk category comprises a low risk category and a moderate risk category.

18. The method of claim 14, wherein calculating the probability score comprises calculating a probability that the risk assessment is associated with the high risk category if the risk assessment contains a given word.

19. The method of claim 14, wherein calculating the risk score comprises summing the plurality of probability scores associated with the plurality of words in the risk.

20. The method of claim 14, further comprising communicating the risk to the second computer if the risk score is an outlier for the associated risk category.
